(19) United States
(12) Patent Application Publication
(10) Pub. No.: US 2020/0377743 A1
(43) Pub. Date: Dec. 3, 2020

(54) SUBSTRATE COATED WITH AN EROSION PROTECTION LAYER

(71) Applicant: ARIANEGROUP SAS, PARIS (FR)

(72) Inventors: Eric CHOCHEYRAS, ST-MEDARD EN JALLES (FR); Jean-Christophe ICHARD, GUJAN MESTRAS (FR); Erwann LE GOFF, LE BOUSCAT (FR)

(21) Appl. No.: 16/954,839

(22) PCT Filed: Dec. 12, 2018
(86) PCT No.: PCT/FR2018/053221

§ 371 Date: Jun. 17, 2020

(30) Foreign Application Priority Data
Dec. 21, 2017 (FR) 1762702

(51) Int. Cl. C09D 7/40; B64C 3/26; B64C 11/20; F01D 5/28; F03D 80/00; C09D 175/04

(52) U.S. Cl. CPC C09D 7/70; B64C 3/26; B64C 11/205; C08K 7/06; F03D 80/00; C09D 175/04; F05B 2280/6011; F01D 5/288

(57) ABSTRACT

A substrate is coated on an outer surface with an erosion protection layer, the protective layer including a resin in which are dispersed fibers having an average length between 50 μm and 500 μm.

### BACKGROUND OF THE INVENTION

Erosion caused by particles such as dust, sand, snow, rain, hail, or salt can lead to a change in the surface condition or even the geometry of a substrate. This erosion can also lead to a degradation of the structural strength of the substrate.

In the special case of blades, such as rotating blades for wind turbines, particle erosion can lead to a change in the surface condition at the leading edge, negatively affecting the aerodynamic properties of the blade. Other elements can be negatively affected by erosion, such as paint compositions used to coat industrial equipment or buildings.

Various solutions have been proposed in order to give substrates increased erosion resistance. These include the application of specific paints and films, mainly polyurethane-based, on the leading edges of wind turbine blades.

However, existing protection techniques have a service life that can be improved. Improvement of this service life would reduce the frequency of maintenance operations. In addition, the service life of a protection product tends to decrease with increasing blade size due to the increase in impact speed, making it even more desirable to have protection that provides improved erosion resistance.

### Subject Matter and Summary of the Invention

The invention relates, according to a first aspect, to a substrate coated on an outer surface with an erosion protection layer, said protective layer comprising a resin in which are dispersed fibers having an average length between 50 μm and 500 μm.

The use of fibers with a particular average length, between 50 μm and 500 μm, gives the substrate improved erosion resistance. Fibers of this length indeed create within the protective layer a network which retains the elements damaged by impact with the particles responsible for erosion. When the fibers have an average length of less than 50 μm or more than 500 μm, the network created does not improve erosion resistance satisfactorily.

In an example embodiment, the average fiber length is between 80 μm and 150 μm.

The use of fibers with such an average length further improves the erosion resistance.

In an example embodiment, the fibers are selected from: carbon fibers, glass fibers, silica fibers, basalt fibers, fibers of natural origin, such as flax fibers, and mixtures thereof. In particular, the fibers can be carbon fibers.

Such fiber types have the advantage of further improving erosion resistance.

In an example embodiment, the fibers are present in the protective layer in a mass content between 0.1% and 30%, for example between 2.5% and 25%.

This feature further improves erosion resistance.

In an example embodiment, the average fiber diameter is less than or equal to 50 μm.

The use of fibers with such an average diameter provides the advantage of obtaining a more homogeneous network, allowing even better retention of damaged elements, and thus further improving erosion resistance.

In an example embodiment, the resin is a polyurethane resin.

In an example embodiment, the protective layer is a layer of paint in which the fibers are dispersed.

In an example embodiment, the substrate has an aerodynamic profile. In particular, the substrate can be chosen from: a blade, an aircraft wing or an aircraft fuselage. In particular, the substrate can be a wind turbine blade.

In an example embodiment, the substrate is made of a composite material comprising a fibrous reinforcement densified by a matrix, or of a metallic material. In particular, the matrix can be an organic matrix.

### BRIEF DESCRIPTION OF THE DRAWINGS

Other features and advantages of the invention will be apparent from the following non-limiting description with reference to the appended drawings, wherein:

FIG. 1 is a schematic representation of a first example of a coated substrate according to the invention,

FIG. 2 is a schematic representation of a second example of a coated substrate according to the invention,

FIG. 3 is a schematic representation of a third example of a substrate coated according to the invention,

FIG. 4 is a schematic representation of a coated wind turbine blade according to the invention,

FIGS. 5A to 5D are photographs of the results of a water erosion test carried out on a coated substrate not of the invention,

FIGS. 6A to 6F are photographs of the results of a water erosion test carried out on a first example of a coated substrate according to the invention, and

FIGS. 7A to 7D are photographs of the results of a water erosion test carried out on a second example of a coated substrate according to the invention.

### DETAILED DESCRIPTION OF EMBODIMENTS

FIG. 1 shows a substrate 1 coated on an outer surface 6 with an erosion protection layer 3. The protective layer 3 may be in contact with the outer surface 6 of the substrate 1. When not coated with the protective layer 3, the outer surface 6 of the substrate 1 is intended to be exposed to a flow of erosion-causing particles, such as water drops or solid particles.

The substrate 1 can be made of composite material and have a fibrous reinforcement densified by a matrix. The matrix can be an organic matrix, such as an epoxy resin. The fibrous reinforcement may consist of glass or carbon reinforcing fibers, or a mixture of such reinforcing fibers. Alternatively, the substrate 1 may be metallic, for example aluminum alloy.

The protective layer 3 comprises a resin 5 in which fibers 7 having an average length between 50 μm and 500 μm are dispersed. “Average length” is the length given by the statistical distribution to half the population (size D50). The mean length of the fibers may be between 80 μm and 150 μm.

As indicated above, the average fiber diameter may be 50 μm or less. The diameter of a fiber refers to its largest transverse dimension. Average diameter is the diameter given by the statistical distribution to half the population.

The fibers 7 can be selected from: carbon fibers, glass fibers, silica fibers, basalt fibers, fibers of natural origin, such as flax fibers, and mixtures thereof. In particular, the fibers 7 can be carbon fibers.

The resin 5 can be a polyurethane resin. Alternatively, the resin 5 can be an epoxy resin.

According to an example, the protective layer 3 can be formed by dispersing the fibers 7 in a paint composition. The protective layer 3 may consist essentially of a paint composition comprising the fibers 7. An example of a paint composition that can be used in the invention is the paint marketed by BASF as “RELEST® Wind HS Topcoat RAL 7035”. The fibers 7 may be present in the protective layer 3 in a mass content greater than or equal to 0.1%, for example greater than or equal to 2.5%, for example greater than or equal to 5%.

The fibers 7 can for example be present in the protective layer 3 in a mass content between 0.1% and 30%, for example between 0.1% and 10%. For example, the fibers 7 may be present in the protective layer 3 in a mass content between 2.5% and 25%, for example between 2.5% and 10%, or even between 5% and 10%.

The thickness e of the protective layer 3 may be greater than or equal to 50 μm, for example 100 μm.

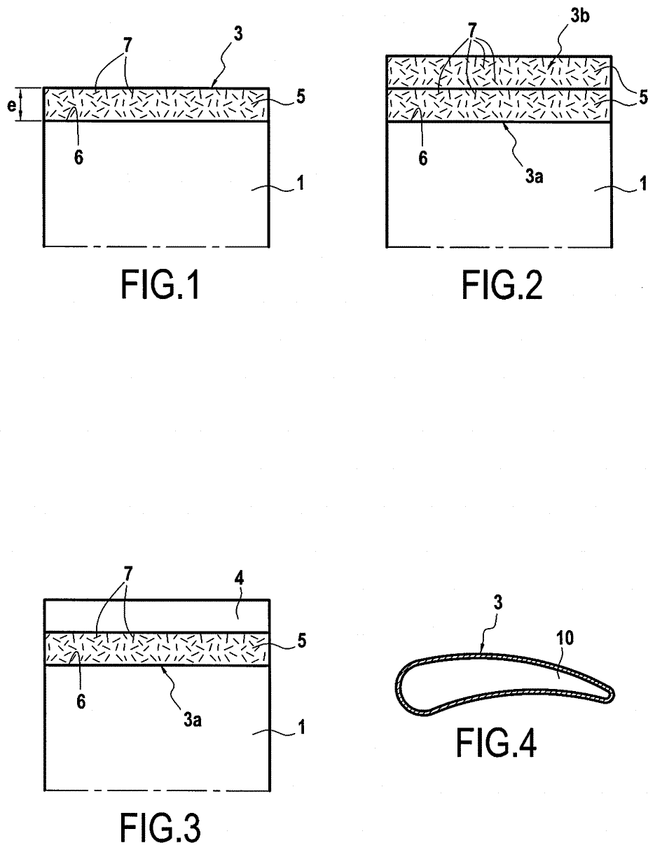

FIG. 2 shows an example embodiment in which the outer surface 6 of the substrate 1 has been coated with several protective layers 3a and 3b filled with the fibers 7. The features of the protective layer 3 described in connection with FIG. 1 apply to each of the protective layers 3a and 3b. The protective layer 3b may be in contact with the protective layer 3a. The protective layer 3b may be the same as or different from the protective layer 3a. An example embodiment with two superimposed protective layers 3a and 3b has been shown. In an alternative not shown, the coating could consist of more than two superimposed layers filled with fibers 7.

In the examples in FIGS. 1 and 2, the outer layer of the coating overlying the substrate 1 (i.e. the layer furthest from the substrate 1) is formed by a layer 3 or 3b filled with fibers 7 of average length between 50 μm and 500 μm. However, it is not beyond the scope of the invention when this is not the case, as will now be described in connection with FIG. 3.

In the case of FIG. 3, the outer layer 4 of the coating overlying the substrate 1 is not filled by the fibers 7. The outer layer 4 can be a paint layer. The outer layer 4 can provide an anti-erosion function or an aesthetic function. The features of the protective layer 3 described in connection with FIG. 1 apply to the protective layer 3a in the example in FIG. 3. The outer layer 4 can be in contact with the protective layer 3. In an alternative not shown, it is possible to have a plurality of superimposed layers each filled with fibers 7, and an outer layer 4 covering these superimposed layers.

FIG. 4 shows an example in which the coated substrate 10 has an aerodynamic profile and here is a blade of wind turbine 10. According to this example, the protective layer 3 covers the leading edge of the substrate 10, among other things. The thickness of the protective layer 3 has been deliberately increased in FIG. 4 to be easier to read.

In this example, the substrate 10 is a rotating part, i.e. a part intended to be rotated. The coated substrate can be a moving part such as a blade, an aircraft wing or an aircraft fuselage. Alternatively, the substrate can be a fixed part such as the surface exposed to the external environment of an industrial equipment or building.

### EXAMPLES

Various tests were carried out to evaluate the improvement in erosion resistance obtained by implementing the invention. The tests were all performed according to standard ASTM G73-10 (“Standard test method for liquid impingement erosion using rotating apparatus”).

### Example 1

### Comparison

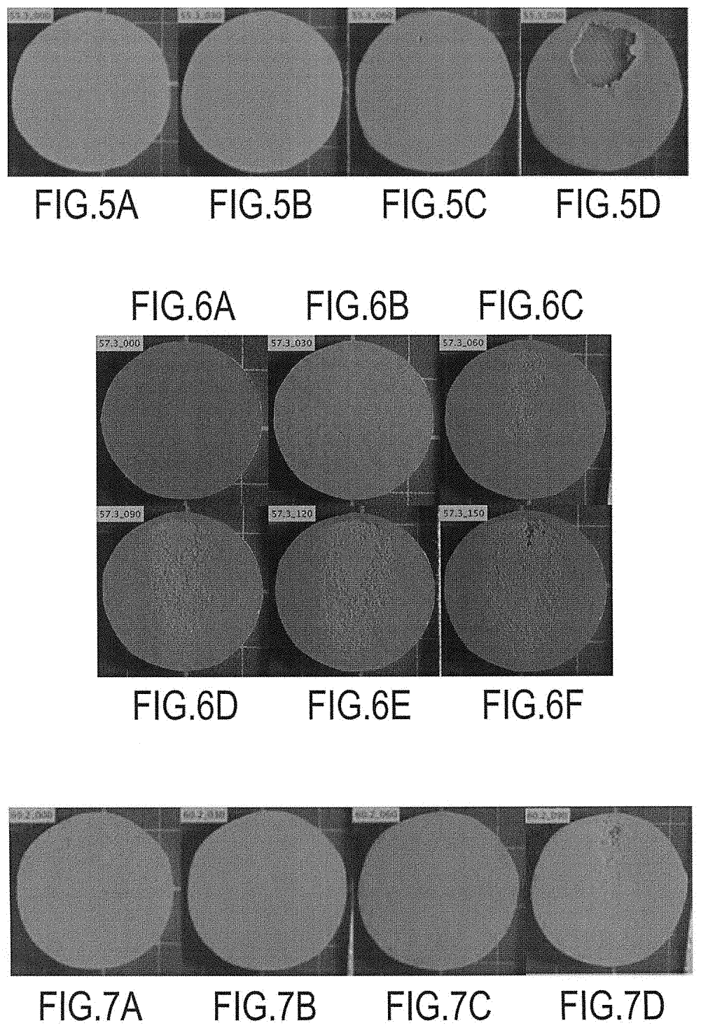

A first test not of the invention was carried out for which the results are given in FIGS. 5A to 5D.

In this test, a paint marketed by BASF as “RELEST® Wind HS Topcoat RAL 7035” was applied to a substrate to form a coating with a thickness of about 150 μm.

FIGS. 5A, 5B, 5C and 5D show the condition of the coating at 0, 30, 60 and 90 minutes, respectively.

The coating begins to be damaged after 60 minutes (FIG. 5C). Following this damage, erosion is then rapid. The coating is found to be completely eroded after 90 minutes (FIG. 5D).

### Example 2

### According to the Invention

A test according to the invention was carried out for which the results are given in FIGS. 6A to 6F.

During this test, carbon fibers cut to an average length of 120 μm were dispersed in the paint marketed by BASF as “RELEST® Wind HS Topcoat RAL 7035”. The average diameter of the fibers used was 7 μm. This composition was then applied to a substrate to form a coating with a thickness of about 150 μm. The coating formed had a carbon fiber content of 10% by mass.

FIGS. 6A, 6B, 6C, 6D, 6E and 6F show the condition of the coating at 0, 30, 60, 90, 120 and 150 minutes, respectively.

The presence of fibers in the protective layer modifies the mode of degradation and improves erosion resistance. When fibers are present, the surface condition of the protective layer is altered rather than eroded. The appearance of a breakthrough in the protective layer is postponed over time.

Visible traces can be seen as early as 60 minutes, indicating the change in the surface condition of the protective layer (FIGS. 6C-6E).

However, the first local breakthrough of the protective layer is only obtained after 150 minutes of testing (FIG. 6F). Furthermore, even after 150 minutes of testing, the protective layer is not completely eroded but only locally pierced, unlike in the test not of the invention according to Example 1 where complete erosion was achieved as early as 90 minutes.

### Example 3

### According to the Invention

A further test according to the invention was carried out for which the results are given in FIGS. 7A to 7D.

This test was identical to that in Example 2 with the difference that the formed coating had a carbon fiber content of 2.5% by mass.

FIGS. 7A, 7B, 7C and 7D show the condition of the coating at 0, 30, 60 and 90 minutes, respectively.

The coating in Example 3 has better erosion resistance than the coating in Example 1. After 90 minutes of testing, a local breakthrough is simply obtained, rather than complete erosion as in the test not of the invention according to Example 1.

The phrase “between . . . and . . . ” should be understood to include the bounds.

1. A substrate coated on an outer surface with an erosion protection layer, said protective layer comprising a resin in which are dispersed fibers having an average length between 50 μm and 500 μm.

2. The coated substrate according to claim 1, wherein the average length of the fibers is between 80 μm and 150 μm.

3. The coated substrate according to any one of claim 1, wherein the fibers are selected from: carbon fibers, glass fibers, silica fibers, basalt fibers, fibers of natural origin and mixtures thereof.

4. The coated substrate according to claim 3, wherein the fibers are carbon fibers.

5. The coated substrate according to any one of claim 1, wherein the fibers are present in the protective layer in a mass content between 0.1% and 30%.

6. The coated substrate according to claim 5, wherein the fibers are present in the protective layer in a mass content between 2.5% and 25%.

7. The coated substrate according to claim 1, wherein the average diameter of the fibers is 50 μm or less.

8. The coated substrate according to any one of claim 1, wherein the resin is a polyurethane resin.

9. The coated substrate according to claim 1, wherein the protective layer is a paint layer in which the fibers are dispersed.

10. The coated substrate according to any one of claim 1, wherein the substrate has an aerodynamic profile.

11. The coated substrate according to claim 10, wherein the substrate is selected from: a blade, an aircraft wing or an aircraft fuselage.

12. The coated substrate according to claim 11, wherein the substrate is a wind turbine blade.

13. The coated substrate according to claim 1, wherein the substrate is of composite material comprising a fibrous reinforcement densified by a matrix, or of metallic material.
